(19) United States
(12) Patent Application Publication
(10) Pub. No.: US 2008/0308673 A1
(43) Pub. Date: Dec. 18, 2008

(54) Secure System and Method for Aircraft Emergency Landing

(76) Inventor: Yuen Liu, Fujian (CN)

Correspondence Address: GREER, BURNS & CRAIN, 300 S WACKER DR, 25TH FLOOR, CHICAGO, IL, 60606, US

(21) Appl. No.: 12/158,566

(22) PCT Filed: Apr. 19, 2007
(86) PCT No.: PCT/CN07/01294

§ 371 Date: Jun. 20, 2008

(30) Foreign Application Priority Data
Apr. 19, 2006 (CN) 200620083398.0

(51) Int. Cl. B64F 1/02

(52) U.S. Cl. 244/110 R

(57) ABSTRACT

A secure system and method for aircraft emergency landing are provided. The system includes a movable board, a detecting device, a controlling system and a buffering device. The detecting device detects the landing location and speed, and transmits the information to the controlling system, which moves the board and makes the moving speed and position of the board match with those of landing aircraft according to the detected information. The aircraft will land on the movable board. The buffering device includes plural independent gas capsules full of antiflaming gas provided on the top surface of the movable board. The gas capsules counteract the aircraft's inertia and absorb the impact force quickly. Plural gas capsules are provided independently from each other. Thus, even though the gas capsules hit aircraft first are broken, remain gas capsules still can perform the function of buffering.

### FIELD OF THE INVENTION

The invention relates to a secure system and method for aircraft emergency landing.

### RELATED ART

Chinese patent application number CN00130125 discloses an invention of “A take-off and landing board system for airplane” in 2002.05.15. The invention provides lifting and descending system of airplane, the lifting and descending of airplane is finished under the assistance of a flat plate, said plate provides extra pushing force and braking force, thereby shortens the distance of lifting and descending of airplane. During lifting and descending, and within a certain period of time, the airplane is relatively static on said flat plate, thereby raises the stability of short distance lifting and descending. The invented system can be flexibly used at different site. It can also be used as force landing means with high safety. But there will be a biggish relative displacement between airplane and flat plate because of the inertia in descending of airplane. Although the invention provides a take-off and landing board system for airplane, but it cannot settle following problems: how to eliminate inertia of airplane itself quickly; how to protect airplane and passengers when there is a relative displacement between airplane and flat plate.

### SUMMARY OF THE INVENTION

The present invention provides a secure system for aircraft emergency landing with disabled undercarriage, which can eliminate impact inertia produced by speed and height and weight in aircraft emergency landing effectively and can protect the aircraft of emergency landing and passengers.

Another purpose of the present invention is to provide a secure method of aircraft emergency landing.

Such object of the present invention will become apparent in the ensuing description.

A secure system for aircraft emergency landing comprises a movable board, a detecting device, a controlling system and a buffering device. The detecting device detects the landing location and speed, and transmits the information to the controlling system, which moves the movable board and makes the moving speed and position of the board match with the landing location and speed of landing aircraft according to the detected information. The movable board moves to the landing location automatically by the controlling of the controlling system. Said buffering device comprises plural independent gas capsules full of antiflaming gas provided on the top surface of the movable board.

Said gas capsules are erect column, wherein plural gas capsules are arranged on the top surface of the movable board regularly.

The height of said gas capsules is bigger than the height from the lowest position of the bottom of the aircraft to the airfoil.

Said gas capsules lean against each other in turns.

Said movable board at least comprises a pair of elasticity poles, wherein each pair of elasticity poles are arranged at both sides of the movable board, and there are at least an elasticity buffering rope between each pair of elasticity poles.

The upright distance between said buffering rope and said movable board is bigger than half height of said gas capsules.

A secure method for aircraft emergency landing comprises steps as follows:

a. detecting landing location and speed of aircraft emergency landing by the detecting device;

b. transmitting the information to the controlling system, and the controlling system moves the movable board and makes the moving speed and position of the movable board match with the landing location and speed of landing aircraft according to the detected information;

c. the aircraft lands on the buffering device provided above the movable board, and the inductor provided on the movable board detects that the aircraft have landed on the movable board, so the brake apparatus controlled by the controlling system work to make movable board decelerate.

Plural gas capsules full of antiflaming gas can counteract the inertia of aircraft and absorb the impact force quickly. Plural gas capsules are provided independently from each other. Thus even though the gas capsules hit aircraft first are broken, remain gas capsules still can perform the function of buffering. The breaking of gas capsules also can counteract some aircraft inertia. The gas capsules are full of antiflaming gas, and the antiflaming gas leaked from the broken gas capsules can prevent the aircraft taking fire or put off the fire.

The present invention has virtues as follows:

Firstly, the buffering device comprises plural independent gas capsules, which can counteract the inertia of aircraft and absorb the impact force quickly and can protect the aircraft of emergency landing and passengers.

Secondly, plural gas capsules are provided independently from each other. Thus even though the gas capsules hit aircraft first are broken, remain gas capsules still can perform the function of buffering. Accompanying with more and more gas capsules the aircraft contacts, the compressive stress of unit area of the gas capsules decreases. Breaking the gas capsules will cost inertia energy of the aircraft. The inertia of the aircraft will decrease gradually to lessen the breaking of the aircraft of emergency landing.

Thirdly, the gas capsules are full of antiflaming gas, and the antiflaming gas leaked from the broken gas capsules can prevent the aircraft taking fire or put off the fire.

Fourthly, the gas capsules are erect column and have a good elasticity, which can counteract the inertia of aircraft and absorb the impact force quickly.

Fifthly, the bottom of the aircraft is curved surface, and the height of said gas capsules is bigger than the height from the lowest position of the bottom of the aircraft to the airfoil, which can prevent that the bottom of the aircraft contact to the movable board to protect the whole aircraft effectively.

Sixthly, plural gas capsules lean against each other in turns, which has a good buffering.

Seventhly, there are elasticity poles and elasticity buffering ropes on the movable board, which can prevent that the aircraft gets off the movable board because of their speed difference. The elasticity poles and the elasticity buffering ropes have elasticity to prevent that the buffering ropes destroy the aircraft, and the elasticity poles and the elasticity buffering ropes can counteract the inertia of aircraft and absorb the impact force quickly.

Eighthly, to match with the aircraft, the upright distance between said buffering rope and said movable board is had best bigger than half height of said gas capsules.

Ninthly, the controlling system controls the movable board to make the moving speed of the movable board match with the moving speed of landing aircraft in a short distance and a short time, to make the aircraft can land on the buffering device of the movable board. Then the inductor detects that the aircraft lands on the movable board, and the brake apparatus work to make the movable decelerate until stopping.

### BRIEF DESCRIPTION OF THE DRAWINGS

FIG. 1 is a structure sketch map of embodiment 1 of the present invention.

FIG. 2 is a schematic diagram of embodiment 1 of the present invention.

FIG. 3 is a movement progress sketch map of the secure system of embodiment 2 of the present invention.

FIG. 4 is an exploded view of movement progress of the secure system of the embodiment 2 of the present invention.

### DETAILED DESCRIPTION OF THE PREFERRED EMBODIMENTS

### Embodiment 1

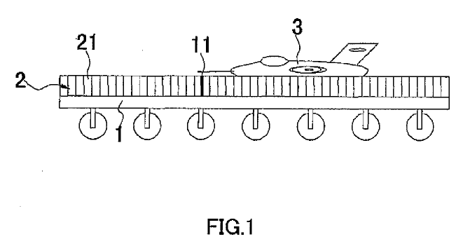

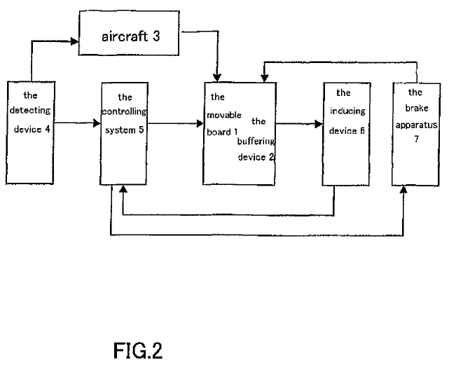

A secure system for aircraft emergency landing, as shown in FIGS. 1 and 2, comprises a movable board 1, a detecting device 4, a controlling system 5, a buffering device 2 and an inducing device 6. The detecting device 4 detects the landing location and speed of the aircraft 3, and transmits the information to the controlling system 5, which moves the movable board 1 and makes the moving speed and position of the movable board match with the landing speed and position of the aircraft 3. The aircraft 3 lands on the buffering device 2 provided above the movable board 1.

The buffering device 2 comprises plural independent gas capsules 21 full of antiflaming gas. The gas capsules 21 are erect column, whose height is bigger than the lowest position of the bottom of the aircraft 3 to the airfoil. Plural gas capsules 21 are arranged on the top surface of the movable board 1 regularly, and plural gas capsules 21 lean against each other in turns.

The movable board 1 comprises a pair of elasticity poles 11, and the pair of elasticity poles 11 are arranged at both sides of the movable board 1, and there are at least an elasticity buffering rope between the pair of elasticity poles 11. The upright distance between the buffering rope and the movable board 1 is equal to half height of the gas capsules 21.

The inducing device 6 comprises an inductor for inducing whether the aircraft 3 lands on the movable board 1, and a brake apparatus 7 is disposed on the movable board 1. The inductor controls the brake apparatus 7 by the controlling system 5

In using, detecting landing location and speed of aircraft 3 of emergency landing by the detecting device 4; transmitting the information to the controlling system 5, and the controlling system 5 moves the movable board 1 and makes the moving speed and position of the movable board 1 match with the landing location and speed of landing aircraft 3 according to the detected information; the aircraft 3 lands on the buffering device 2 provided on above the movable board 1; the inductor disposed on the movable board 1 works to start the brake apparatus 7 to make the movable board 1 decelerate. The buffering device 2 comprises plural gas capsules 21. The gas capsules 21 full of antiflaming gas can counteract the inertia of the aircraft 3 and absorb the impact force quickly. Plural gas capsules are provided independently from each other. Thus even though the gas capsules hit the aircraft first are broken, remain gas capsules still can perform the function of buffering, to prevent the aircraft break all gas capsules. The breaking of gas capsules also can counteract some aircraft inertia. The gas capsules are full of antiflaming gas, and the antiflaming gas leaked from the broken gas capsules can prevent the aircraft taking fire or put off the fire, which can protect the aircraft of emergency landing and passengers.

### Embodiment 2

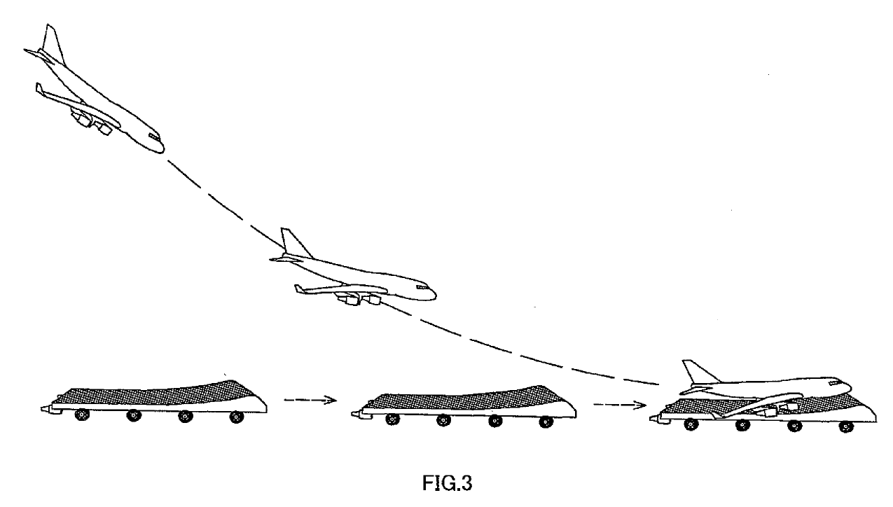

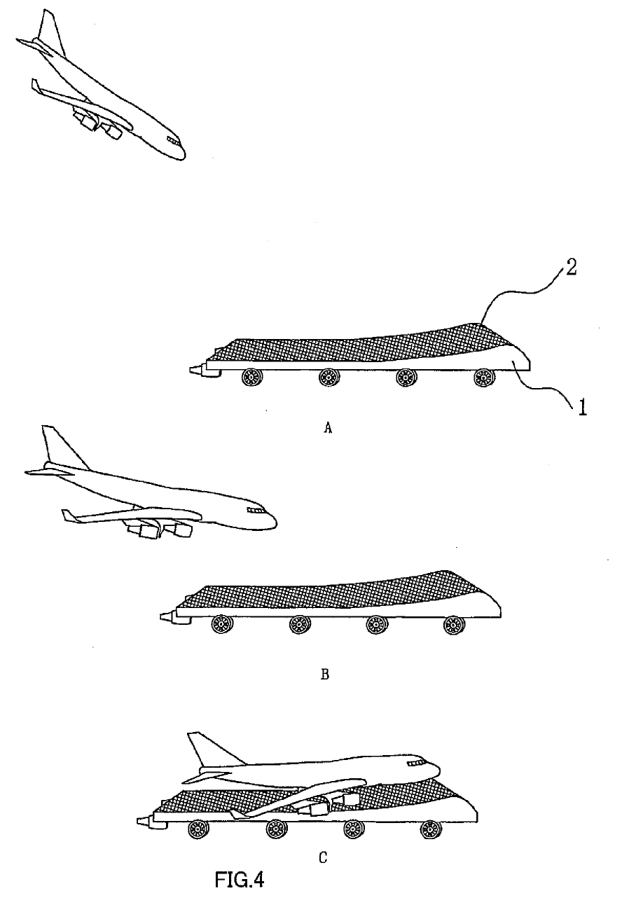

As shown in FIGS. 3 and 4, the embodiment 2 has difference with the embodiment 1 as follows: the buffering device 2 comprises plural independent gas capsules full of antiflaming gas that is carbon dioxide. The gas capsules 21 are erect column, whose height is bigger than the height from the bottom of the aircraft to the airfoil. Plural gas capsules 21 are arranged on the top surface of the movable board regularly. The top surface of the movable board 1 has a lower front part and a higher back part to increase the resistance of the landing of the aircraft.

As shown in FIGS. 3 and 4, a secure method for aircraft emergency landing, comprising steps as follows:

a. detecting landing location and speed of aircraft emergency landing by the detecting device (as shown in FIGS. 3A and 4A);

b. transmitting the information to the controlling system, and the controlling system moves the movable board and makes the moving speed and position of the movable board match with the landing location and speed of landing aircraft according to the detected information (as shown in FIGS. 3B and 4B); temporality the aircraft is decelerating.

c. the aircraft lands on the buffering device provided above the movable board, and the inductor provided on the movable board detects that the aircraft have landed on the movable board, so the brake apparatus controlled by the controlling system work to make movable board decelerate (as shown in FIGS. 3C and 4C) until stopping.

The gas capsules full of antiflaming gas can counteract the inertia of aircraft and absorb the impact force quickly. Plural gas capsules are provided independently from each other. Thus even though the gas capsules hit aircraft first are broken, remain gas capsules still can perform the function of buffering. The breaking of gas capsules also can counteract some aircraft inertia. The gas capsules are full of antiflaming gas, and the antiflaming gas leaked from the broken gas capsules can prevent the aircraft taking fire or put off the fire.

The movable board also has automatic device for putting out a fire. If the aircraft starts a fire, the automatic device can work automatically to put out the fire.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

### INDUSTRY PRACTICABILITY

The secure system for aircraft emergency landing of the present invention is designed skillfully, and utilizes plural gas capsules as buffering device, which has a good industry practicability.

1. A secure system for aircraft emergency landing comprises a movable board and a buffering device; the aircraft lands on the movable board; said buffering device comprises plural independent gas capsules full of antiflaming gas provided on the top surface of the movable board.

2. The secure system for aircraft emergency landing according to claim 1, also comprises a detecting device and a controlling system; the detecting device detects the landing location and speed of the aircraft, and transmits the information to the controlling system, which moves the movable board and makes the moving speed and position of the board match with the landing location and speed of landing aircraft according to the detected information; the movable board moves to the landing position automatically controlled by the controlling system.

3. The secure system for aircraft emergency landing according to claims 1, wherein said gas capsules are erect columns; plural gas capsules are arranged on the top surface of the movable board regularly; the top surface of the movable board can be planar or with a rough surface or an inclined plane with a small obliquity.

4. The secure system for aircraft emergency landing according to claim 3, wherein the height of said gas capsules is bigger than the height from the lowest position of the bottom of the aircraft to the airfoil.

5. The secure system for aircraft emergency landing according to claim 3, wherein said plural gas capsules lean against each other in turns.

6. The secure system for aircraft emergency landing according to claim 3, wherein said movable board at least comprises a pair of elasticity poles, wherein each pair of elasticity poles are arranged at both sides of the movable board, and there is at least one elasticity buffering rope between each pair of elasticity poles.

7. The secure system for aircraft emergency landing according to claim 6, wherein the upright distance between said buffering rope and said movable board is bigger than half height of said gas capsules.

8. The secure system for aircraft emergency landing according to claim 1, also comprises an inductor for inducing whether the aircraft lands on the movable board, and a brake apparatus is disposed on the movable board 1; the inductor controls the brake apparatus by the controlling system.

9. The secure system for aircraft emergency landing according to claim 1, wherein the movable board also has an automatic device for putting out a fire.

10. A secure method for aircraft emergency landing, comprising steps as follows:
a. detecting landing location and speed of aircraft emergency landing by the detecting device;
b. transmitting the information to the controlling system, and the controlling system moves the movable board and makes the moving speed and position of the movable board match with the landing location and speed of landing aircraft according to the detected information;
c. the aircraft lands on the buffering device provided on the top of the movable board, and the inductor provided on the movable board detects that the aircraft has landed on the movable board, so the brake apparatus controlled by the controlling system makes the movable board decelerate;
the gas capsules full of antiflaming gas can counteract the inertia of aircraft and absorb the impact force quickly; plural gas capsules are provided independently from each other; thus even though the gas capsules hit by the aircraft first are broken, remaining gas capsules still can perform the function of buffering; the breaking of gas capsules also can counteract some aircraft inertia; the gas capsules are full of antiflaming gas, and the antiflaming gas leaked from the broken gas capsules can prevent the aircraft catching fire or put out a fire.

11. The secure system for aircraft emergency landing according to claim 10, wherein said gas capsules are erect columns; plural gas capsules are arranged on the top surface of the movable board regularly.

12. The secure system for aircraft emergency landing according to claim 10, wherein the movable board also has an automatic device for putting out a fire; if the aircraft starts a fire, the automatic device can work automatically to put out the fire.
